(19) United States
(12) Patent Application Publication
(10) Pub. No.: US 2017/0273855 A1
(43) Pub. Date: Sep. 28, 2017

(54) DO-IT-YOURSELF MASSAGER

(71) Applicant: Ho-Chun Liu, Tainan City (TW)

(72) Inventor: Ho-Chun Liu, Tainan City (TW)

(21) Appl. No.: 15/076,695

(22) Filed: Mar. 22, 2016

(51) Int. Cl. A61H 7/00

(52) U.S. Cl. CPC A61H 7/003; A61H 2205/081; A61H 2201/1253

(57) ABSTRACT

A massager includes a massaging bar and a handle. The massaging bar includes a shank and a massaging block. The shank has a first end connected with the handle and a second end formed with a curved section. The curved section has a distal end formed with an inward bending portion which bends and extends toward the shank. The inward bending portion has a hook-shaped profile, with a bending angle being defined between the inward bending portion and the curved section. The massaging block is mounted on the inward bending portion. Thus, the inward bending portion has the bending angle with a determined orientation, so that the inward bending portion can exactly transmit a user's force to the massaging block of the massaging bar, such that the massaging block can press the user's back actually.

### BACKGROUND OF THE INVENTION

### 1. Field of the Invention

The present invention relates to a massager and, more particularly, to a massager with a do-it-yourself (D.I.Y.) function.

### 2. Description of the Related Art

A conventional massager comprises a substantially 7-shaped bar. The bar is provided with a handle. The handle has a first end provided with a scraping portion and a second end connected with a massaging barb. The massaging barb is provided with a transverse extension extending transversely from an end portion of the handle. The transverse extension has an end portion integrally formed with a pointed pressing protrusion which extends in a direction that is parallel with that of the handle. When in use, the massaging barb extends to a user's back to press and massage the user's back. In such a manner, the pointed pressing protrusion of the massaging barb extends in a direction that is parallel with that of the handle, so that when the handle is pulled downward and forward by the user's hand, only a side of the pointed pressing protrusion presses the human body. However, the direction and the angle of the pointed pressing protrusion are not correct, so that the force applied by the user's hands cannot be transmitted completely to the pointed pressing protrusion. Thus, the pointed pressing protrusion cannot press the user's back exactly and deeply, thereby decreasing the massaging effect of the massager.

### BRIEF SUMMARY OF THE INVENTION

The primary objective of the present invention is to provide a massager that can massage a user's back by himself or herself without needing aid of other person.

In accordance with the present invention, there is provided a massager comprising a massaging bar and a handle connected with the massaging bar. The massaging bar includes a shank and a massaging block connected with the shank. The shank of the massaging bar has a first end connected with the handle and a second end formed with a curved section which extends downward. The curved section of the shank has a distal end formed with an inward bending portion which bends and extends toward the shank. The inward bending portion of the shank has a hook-shaped profile, with a bending angle being defined between the inward bending portion and the curved section of the shank. The massaging block of the massaging bar is mounted on a distal end of the inward bending portion of the shank. Thus, the inward bending portion of the massaging bar has the bending angle with a determined orientation, so that the inward bending portion of the massaging bar can exactly transmit a user's force to the massaging block of the massaging bar, such that the massaging block of the massaging bar can press the user's back actually.

Preferably, the handle has a first end connected with the shank of the massaging bar and a second end formed with a stop piece.

Preferably, the shank, the curved section and the inward bending portion of the massaging bar are molded and formed integrally.

Preferably, the shank, the curved section and the inward bending portion of the massaging bar are made of metallic material.

Preferably, the shank, the curved section and the inward bending portion of the massaging bar are made of stainless steel or galvanized iron.

Preferably, the massaging block of the massaging bar has a spherical shape.

According to the primary advantage of the present invention, the curved section of the shank has a distal end formed with an inward bending portion which has a bending angle with a determined orientation, so that the inward bending portion of the massaging bar can exactly transmit the force applied by the user to the massaging block, such that the massaging block can press a determined position of the user's body actually and precisely so as to enhance the massaging effect of the massaging bar.

According to another advantage of the present invention, the shank, the curved section and the inward bending portion of the massaging bar are made of metallic material, so that the shank, the curved section and the inward bending portion of the massaging bar are not easily distorted or deformed when the massaging bar is subjected to a larger pulling force applied by the user, thereby enhancing the lifetime of the massager.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a front view of a massager in accordance with the preferred embodiment of the present invention.

FIG. 2 is a schematic operational view of the massager as shown in FIG. 1 in use.

### DETAILED DESCRIPTION OF THE INVENTION

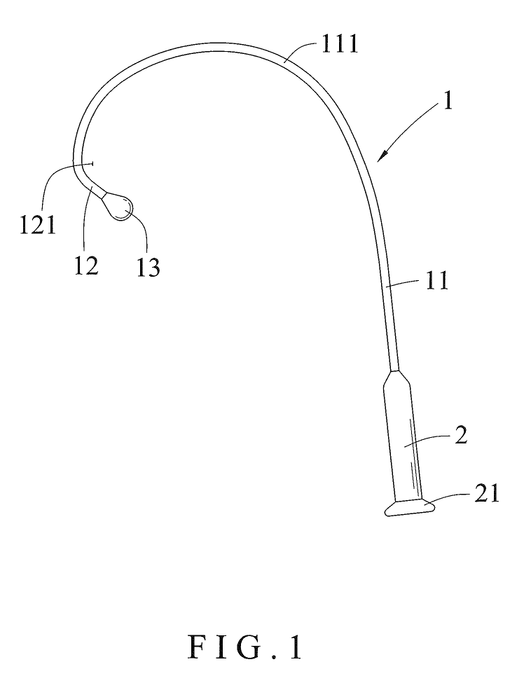

Referring to the drawings and initially to FIG. 1, a massager in accordance with the preferred embodiment of the present invention comprises a massaging bar 1 and a handle 2 connected with the massaging bar 1.

The massaging bar 1 includes a shank 11 and a massaging block 13 connected with the shank 11.

The shank 11 of the massaging bar 1 has a first end connected with the handle 2 and a second end formed with a curved section 111 which extends downward. The curved section 111 of the shank 11 has a distal end formed with an inward bending portion 12 which bends and extends toward the shank 11. The inward bending portion 12 of the shank 11 has a hook-shaped profile, with a bending angle 121 being defined between the inward bending portion 12 and the curved section 111 of the shank 11.

The massaging block 13 of the massaging bar 1 is mounted on a distal end of the inward bending portion 12 of the shank 11. Preferably, the massaging block 13 of the massaging bar 1 has a spherical shape.

The handle 2 has a first end connected with the shank 11 of the massaging bar 1 and a second end formed with a stop piece 21.

In the preferred embodiment of the present invention, the shank 11, the curved section 111 and the inward bending portion 12 of the massaging bar 1 are molded and formed integrally. In addition, the shank 11, the curved section 111 and the inward bending portion 12 of the massaging bar 1 are made of metallic material to enhance the structural strength and malleability of the massaging bar 1. Preferably, the shank 11, the curved section 111 and the inward bending portion 12 of the massaging bar 1 are made of stainless steel or galvanized iron.

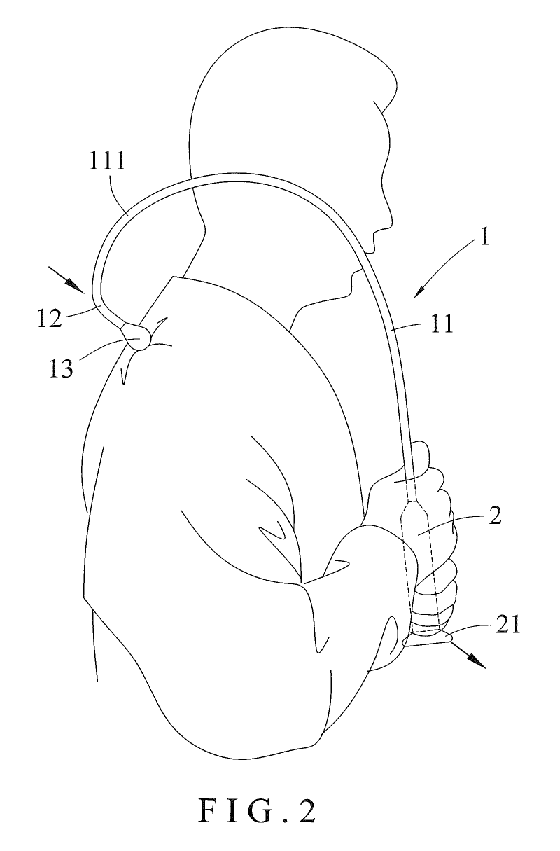

In operation, referring to FIG. 2 with reference to FIG. 1, the handle 2 is held by a user's hands. Then, the curved section 111 of the shank 11 passes the user's shoulder, with the inward bending portion 12 of the shank 11 extending to the user's back, so that the massaging block 13 of the massaging bar 1 abuts the user's back. Then, the massaging bar 1 is pulled forward by the user, so that the massaging block 13 of the massaging bar 1 is driven to press, rub and knead the user's back, thereby providing a massaging effect to the user's back so as to promote relaxation to and increase blood circulation of the user's body. In such a manner, the shank 11, the curved section 111 and the inward bending portion 12 of the massaging bar 1 are made of metallic material, so that the shank 11, the curved section 111 and the inward bending portion 12 of the massaging bar 1 are not easily distorted or deformed when the massaging bar 1 is subjected to the user's forward pulling force. In addition, the inward bending portion 12 of the massaging bar 1 has the bending angle 121 with a specific orientation, so that the inward bending portion 12 of the massaging bar 1 can exactly transmit the user's force to the massaging block 13 of the massaging bar 1, such that the massaging block 13 of the massaging bar 1 can press the user's back actually and deeply.

Accordingly, the curved section 111 of the shank 11 has a distal end formed with an inward bending portion 12 which has a bending angle 121 with a determined orientation, so that the inward bending portion 12 of the massaging bar 1 can exactly transmit the force applied by the user to the massaging block 13, such that the massaging block 13 can press a determined position of the user's body actually and precisely so as to enhance the massaging effect of the massaging bar 1. In addition, the shank 11, the curved section 111 and the inward bending portion 12 of the massaging bar 1 are made of metallic material, so that the shank 11, the curved section 111 and the inward bending portion 12 of the massaging bar 1 are not easily distorted or deformed when the massaging bar 1 is subjected to a larger pulling force applied by the user, thereby enhancing the lifetime of the massager.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A massager comprising:
a massaging bar; and
a handle connected with the massaging bar;
wherein:
the massaging bar includes:
a shank; and
a massaging block connected with the shank;
the shank of the massaging bar has a first end connected with the handle and a second end formed with a curved section which extends downward;
the curved section of the shank has a distal end formed with an inward bending portion which bends and extends toward the shank;
the inward bending portion of the shank has a hook-shaped profile, with a bending angle being defined between the inward bending portion and the curved section of the shank;
the massaging block of the massaging bar is mounted on a distal end of the inward bending portion of the shank; and
the inward bending portion of the massaging bar has the bending angle with a determined orientation, so that the inward bending portion of the massaging bar can exactly transmit a user's force to the massaging block of the massaging bar, such that the massaging block of the massaging bar can press the user's back actually.

2. The massager of claim 1, wherein the handle has a first end connected with the shank of the massaging bar and a second end formed with a stop piece.

3. The massager of claim 1, wherein the shank, the curved section and the inward bending portion of the massaging bar are molded and formed integrally.

4. The massager of claim 1, wherein the shank, the curved section and the inward bending portion of the massaging bar are made of metallic material.

5. The massager of claim 4, wherein the shank, the curved section and the inward bending portion of the massaging bar are made of stainless steel or galvanized iron.

6. The massager of claim 4, wherein the massaging block of the massaging bar has a spherical shape.
